(19) United States
(12) Patent Application Publication
(10) Pub. No.: US 2012/0310561 A1
(43) Pub. Date: Dec. 6, 2012

(54) METHODS AND SYSTEMS FOR ESTIMATING BATTERY HEALTH

(75) Inventors: Justin Dale Middleton, Peoria, IL (US); Benjamin Arthur Treichel, Peoria, IL (US); Wellington Ying-Wei Kwok, Dunlap, IL (US); John Joseph Votoupal, Hudson, IL (US)

(73) Assignee: Caterpillar Inc.

(21) Appl. No.: 13/149,239

(22) Filed: May 31, 2011

(51) Int. Cl. G06F 19/00

(52) U.S. Cl. 702/63

(57) ABSTRACT

A method of estimating a state of health of a battery is disclosed. The method may include receiving information indicative of a history of electricity received by and discharged from the battery during a time period. The method may also include using the received information to estimate peaks in the electricity during the time period. Additionally, the method may include using an information processor to determine a parameter indicative of an estimated state of health of the battery based at least in part on an estimated magnitude of electricity at each of a plurality of the estimated peaks.

### TECHNICAL FIELD

The present disclosure relates to batteries and, more particularly, to methods and systems for estimating the state of health of batteries.

### BACKGROUND

Many machines include a power system with one or more electrical loads and a battery for supplying electricity to one or more of those electrical loads. For example, many hybrid-electric machines include a power system with a prime mover that drives an electric motor/generator to supply electricity to one or more electric motors of the machine. Such hybrid-electric machines also often include one or more batteries that may serve to supply electricity to the electric motors at times. As used herein, the term “battery” refers to any type of device operable to store electrical energy and exchange electricity with (i.e., receive electricity from and deliver electricity to) other electrical components of a power system. Batteries typically cycle between discharging electricity to power the electrical power loads and receiving electricity to recharge. Over time, a number of factors can degrade the components of hybrid-electric and other power systems. For example, the charging and discharging cycles experienced by a battery in a hybrid-electric power system can gradually diminish the ability of the battery to receive and hold charge. Additionally, mechanical stresses due to various factors can degrade various components of the power system.

U.S. Pat. No. 7,653,510 to Hirohata et al. (“the '510 patent”) discloses a device and method useable to predict failure of an electronic component that includes a CPU (central processing unit), a memory device, and fans. The device and method of the '510 patent performs analysis related to mechanical fatigue experienced by the component. The device and method of the '510 patent performs its analysis based on various factors, including a performance characteristic that includes, for example, use frequency, element performance, fan rotation speed, battery remaining charge, or an element load factor. The '510 patent discloses that its device and method may use cycle counting, such as a “rain flow” cycle counting method, in evaluating the mechanical fatigue experienced by the component, in order to predict mechanical failure of the component.

Although the method and system of the '510 patent may help evaluate the mechanical stresses and predict mechanical failure of a system, certain disadvantages may persist. For example, the device and method disclosed by the '510 patent does not provide any insight regarding the electrical state of health of a battery.

The system and methods of the present disclosure solve one or more of the problems set forth above.

### SUMMARY

One disclosed embodiment relates to a method of estimating a state of health of a battery. The method may include receiving information indicative of a history of electricity received by and discharged from the battery during a time period. The method may also include using the received information to estimate peaks in the electricity during the time period. Additionally, the method may include using an information processor to determine a parameter indicative of an estimated state of health of the battery based at least in part on an estimated magnitude of electricity at each of a plurality of the estimated peaks.

Another embodiment relates to a method of estimating a state of health of a battery. The method may include receiving information indicative of a history of electricity received by and discharged from the battery during a time period. The method may also include using the received information to identify a plurality of discharging cycles and charging cycles during the time period. Additionally, the method may include using an information processor to determine a parameter indicative of an estimated state of health of the battery based at least in part on how many of the discharging cycles and charging cycles are identified for the time period.

A further disclosed embodiment relates to a method of estimating a state of health of a battery. The method may include receiving information indicative of a history of electricity received by and discharged from the battery during a time period. The method may also include using the received information with an information processor to determine for each of a plurality of segments of the time period a degradation value representative of an amount of battery degradation during the segment. Additionally, the method may include using the information processor to determine a parameter indicative of an estimated state of health of the battery based at least in part on a plurality of the degradation values.

### BRIEF DESCRIPTION OF THE DRAWINGS

FIG. 1A shows one embodiment of a machine having a power system according to the present disclosure;

FIG. 1B shows one embodiment of a power system according to the present disclosure in more detail;

FIG. 2 graphically illustrates one example of a history of electricity discharged from and received by a battery;

FIG. 3A is a flow chart providing an overview of one embodiment of a method according to the present disclosure;

FIG. 3B is a flow chart providing greater detail regarding a portion of the method shown in FIG. 3A;

FIG. 3C is a flow chart providing greater detail regarding another portion of the method shown in FIG. 3A;

FIG. 4A provides an example of some parameters used during one iteration of the method shown in FIGS. 3A-3C;

FIG. 4B provides an example of some parameters used during another iteration of the method shown in FIGS. 3A-3C;

FIG. 4C provides an example of some parameters used during another iteration of the method shown in FIGS. 3A-3C;

FIG. 4D provides an example of some parameters used during another iteration of the method shown in FIGS. 3A-3C;

FIG. 4E provides an example of some parameters used during another iteration of the method shown in FIGS. 3A-3C;

FIG. 4F provides an example of some parameters used during another iteration of the method shown in FIGS. 3A-3C;

FIG. 4G provides an example of some parameters used during another iteration of the method shown in FIGS. 3A-3C;

FIG. 4H provides an example of some parameters used during another iteration of the method shown in FIGS. 3A-3C; and

FIG. 5 illustrates one example of a lookup table that may be used in connection with the method shown in FIGS. 3A-3C.

### DETAILED DESCRIPTION

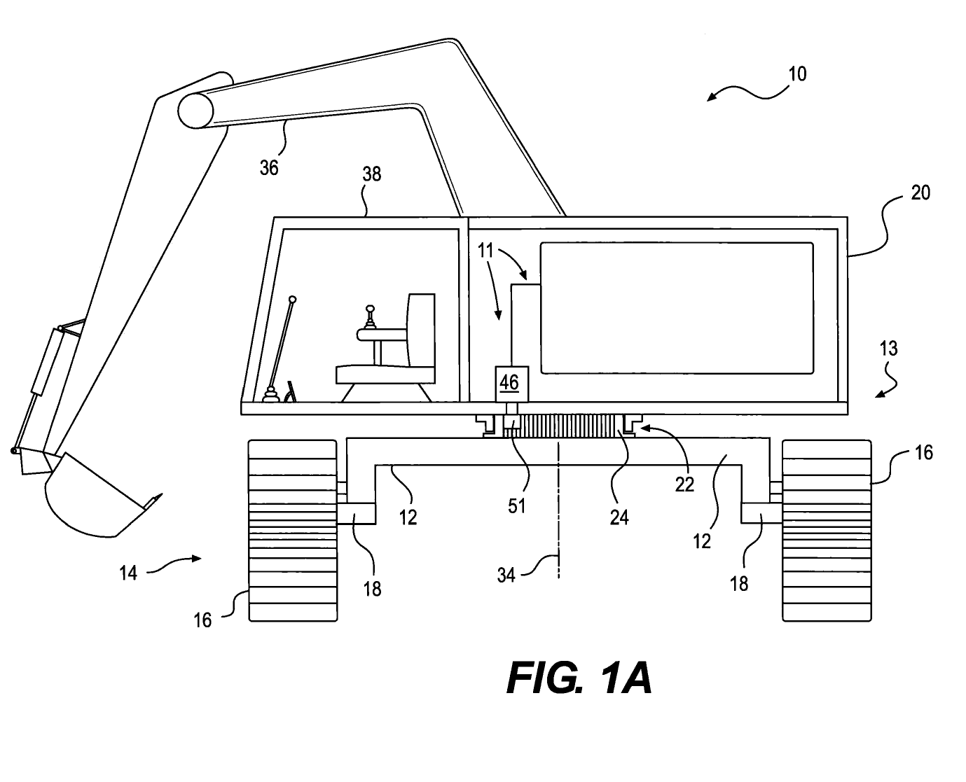

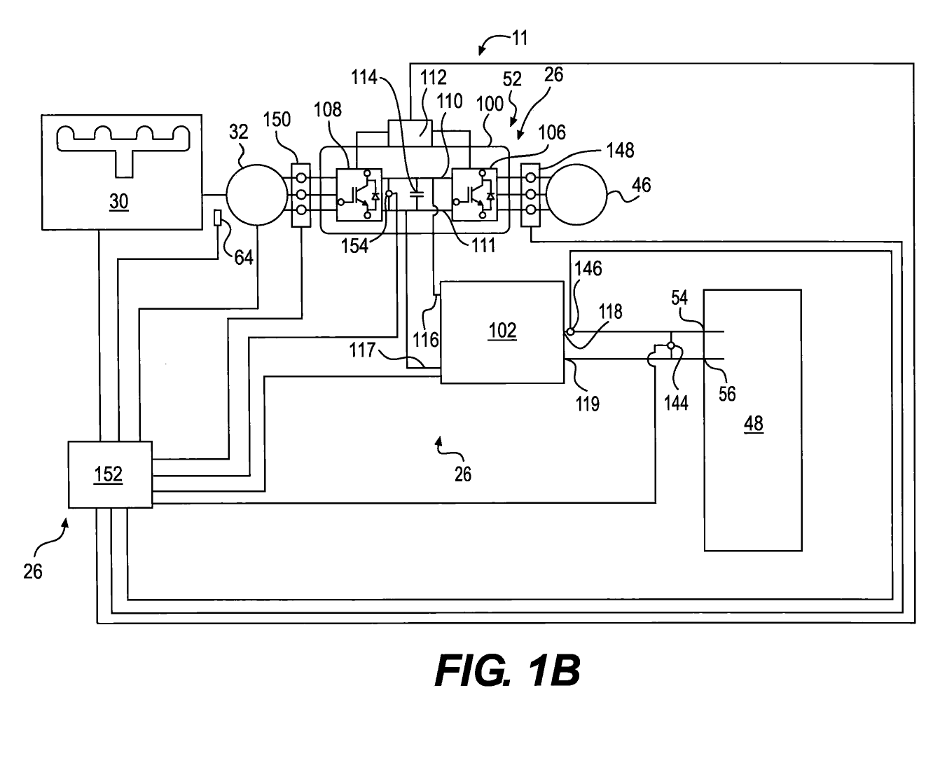

FIGS. 1A and 1B show a machine 10, a power system 11, and various components thereof according to the present disclosure. Machine 10 may be any type of machine that employs power to perform one or more tasks. For example, machine 10 may be a mobile machine configured to transport or move people, goods, or other matter or objects. Additionally, or alternatively, machine 10 may be configured to perform a variety of other operations associated with a commercial or industrial pursuit, such as mining, construction, energy exploration and/or generation, manufacturing, transportation, and agriculture.

As shown in FIG. 1A, in some embodiments, machine 10 may be an excavator configured for digging. Machine 10 may include a chassis 13 to which other components of machine 10 are attached. In some embodiments, chassis 13 may be constructed in part or in whole from electrically conductive materials, such as steel, cast iron, aluminum, and/or other electrically conductive metals. In the example shown in FIG. 1, chassis 13 may include an undercarriage 14 and a superstructure 20. Undercarriage 14 may include a frame 12. In some embodiments, machine 10 may be a mobile machine, and undercarriage 14 may include one or more propulsion devices 16 for propelling machine 10. Propulsion devices 16 may be any type of device configured to propel machine 10. For example, as FIG. 1 shows, propulsion devices 16 may be track units. Alternatively, propulsion devices 16 may be wheels or other types of devices operable to propel machine 10. Undercarriage 14 may also include one or more components for driving propulsion devices 16. For example, undercarriage 14 may include drive motors 18 for driving propulsion devices 16. Drive motors 18 may be electric motors or hydraulic motors.

Superstructure 20 may be suspended from frame 12. In some embodiments superstructure 20 may be suspended from frame 12 by a pivot system 22. Pivot system 22 may include a swing bearing 24 and an electric motor 46. Swing bearing 24 may include an inner race mounted to frame 12 and an outer race to which superstructure 20 mounts. Both the inner and outer race of swing bearing 24 may extend concentric to a vertical axis 34. The inner and outer race may be engaged to one another via rolling elements (not shown), such as ball bearings, in such a manner that the outer race and superstructure 20 may pivot around axis 34 relative to frame 12.

Electric motor 46 may be operable to rotate superstructure 20 and the outer race of swing bearing 24 around axis 34. Electric motor 46 may have a gear 51 mounted to its output shaft, and electric motor 46 may mount to superstructure 20 in a position such that gear 51 meshes with gear teeth on frame 12. Electric motor 46 may receive power to rotate superstructure 20 around axis 34 from various components of power system 11. Electric motor 46 may constitute one of many electrical power loads of power system 11.

Machine 10 may include various other components. For example, as FIG. 1A shows, machine 10 may include an implement 36. Implement 36 may be mounted to various parts of machine 10 and configured to perform various tasks. In some embodiments, implement 36 may be mounted to superstructure 20 and configured to perform digging. Machine 10 may also include an operator station 38 from which an individual can control one or more aspects of the operation of machine 10. Operator station 38 may also be mounted to superstructure 20.

FIG. 1B shows power system 11 in greater detail. Power system 11 may include power-system controls 26 and various components operable to provide power to perform various tasks. In some embodiments, power system 11 may be a hybrid-electric power system. In addition to power-system controls 26, power system 11 may include electric motor 46, a prime mover 30, an electric motor/generator 32, a battery 48, and a power-transmission system 52. As used herein, the term “electric motor/generator” refers to any electrical device operable to operate as an electric motor when receiving electrical power and/or to operate as an electric generator when being mechanically driven.

Prime mover 30 may be any type of device configured to produce mechanical power to drive electric motor/generator 32. For example, prime mover 30 may be a diesel engine, a gasoline engine, a gaseous fuel-powered engine, or any other type of component operable to produce mechanical power.

Electric motor/generator 32 may be any type of component operable to generate electricity with mechanical power received from prime mover 30. Electric motor/generator 32 may also be operable to receive electricity and operate as an electric motor to drive prime mover 30 for a number of purposes. Electric motor 46 may be any type of component operable to receive electricity from power-transmission system 52 and operate as an electric motor. Each of electric motor/generator 32 and electric motor 46 may be, for example, any of a permanent-magnet electric machine, a switched reluctance electric machine, a DC electric machine, an induction-type machine or any other type of electric machine known in the art.

Battery 48 may be any type of device operable to store electrical energy and exchange electricity with (i.e., receive electricity from and deliver electricity to) power-transmission system 52. Battery 48 may include a positive terminal 54 and a negative terminal 56. Battery 48 may be electrically isolated from the chassis 13 of machine 10.

Power-transmission system 52 may include an inverter 100, a power regulator 102, and various electrical connectors, such as electric lines and/or electric switches connecting these devices. Inverter may 100 include a power electronics unit 106, a power electronics unit 108, power lines 110, 111, a bulk capacitor 114, and a controller 112. Power electronics unit 106 may be operable to regulate a flow of power between electric motor 46 and power lines 110, 111. Power electronics module 106 may also be operable to convert the form of electricity flowing between electric motor 46 and power lines 110, 111. For example, power electronics unit 106 may be operable to convert between alternating electric current at electric motor 46 and direct current at power lines 110, 111. Power electronics module 108 may similarly be operable to regulate a flow of power between electric motor/generator 32 and power lines 110, 111. Power electronics module 108 may also be able to convert the form of electricity flowing between electric motor/generator 32 and power lines 110, 111, such as converting between alternating current electricity at electric motor/generator 32 and direct current electricity at power lines 110, 111. Power electronics modules 106-108 may include various types of controllable electric components for regulating and/or converting electrical power, including, but not limited to SCRs (sillicon controller rectifiers), GTOs (gate turn-offs), IGBTs (insulated gate bipolar transistors), and FETs (field-effect transistors). Bulk capacitor 114 may be connected between power lines 110, 111 and serve to smooth out any fluctuations in voltage across power lines 110, 111. This configuration of inverter 100 may allow exchange of electricity between electric motor/generator 32 and electric motor 46 via power electronics modules 106, 108 and power lines 110, 111.

Controller 112 may be operatively connected to power electronics modules 106, 108, and controller 112 may be configured (e.g., programmed) to control one or more aspects of the operation of power electronics modules 106, 108. In some embodiments, controller 112 may include, for example, one or more microprocessors and/or one or more memory devices. By controlling power electronics modules 106, 108, controller 112 may be operable to control the voltage on power lines 110, 111, as well as the magnitude of current flowing between power lines 110, 111, electric motor 46, and electric motor/generator 32.

Power regulator 102 may include input/output terminals 116, 117, 118, 119. Power regulator 102 may have any configuration that allows it to regulate one or more aspects of electricity exchanged between terminals 116, 117 and terminals 118, 119. Power regulator 102 may, for example, be operable to control whether electricity is exchanged between terminals 116, 117 and terminals 118, 119. Power regulator 102 may also be configured to control which direction electricity flows between terminals 116, 117 and terminals 118, 119, i.e., whether electricity flows from terminals 116, 117 to terminals 118, 119, or vice-a-versa. Power regulator 102 may exchange electricity in various forms. In some embodiments, power regulator 102 may be configured to receive and/or supply direct current electricity at terminals 116, 117, 118, 119. Power regulator 102 may also be operable to control the voltage at each of terminals 116, 117, 118, 119 as well as the magnitude of electric current flowing at each of terminals 116, 117, 118, 119. For example, power regulator 102 may be operable to change the electricity transmitted between terminals 116, 117 and terminals 118, 119 from one voltage (such as approximately 650 volts) of direct current electricity at terminals 116, 117 to another voltage (such as approximately 350 volts) of direct current electricity at terminals 118, 119. As discussed further below, power regulator 102 may be controllable by one or more other component(s) of power system 11, so that those other components may control how power regulator 102 controls the exchange of electricity between terminals 116, 117 and terminals 118, 119. Power regulator 102 may include any suitable configuration of components that allows it to provide the above-discussed functionality.

Inverter 100, power regulator 102, battery 48, electric motor 46, and electric motor/generator 32 may be electrically connected to one another in various ways. As FIG. 1B shows, in some embodiments, terminals 116, 117 of power regulator 102 may be electrically connected to power lines 110, 111 of inverter 100. This may allow exchange of electricity between power regulator 102, electric motor 46, and electric motor/generator 32 via power lines 110, 111 of inverter 100. Additionally, power-transmission system 52 may have provisions connecting terminals 118, 119 of power regulator 102 directly or indirectly to battery 48. For example, terminals 118, 119 of power regulator 102 may, for example, be continuously electrically connected to terminals 54 and 56 of battery 48.

The exemplary configuration of power-transmission system 52 shown in FIG. 1B may allow it to transmit electricity between electric motor/generator 32, electric motor 46, and battery 48 in various ways through inverter 100 and power regulator 102. For example, power-transmission system 52 may transmit electricity from electric motor/generator 32, through inverter 46, to electric motor 46, thereby operating electric motor 46 to rotate superstructure 20. Additionally or alternatively, power-transmission system 52 may at times transmit electricity from battery 48, through power regulator 102, to inverter 100, to electric motor 46 to rotate superstructure 20. At other times, power-transmission system 52 may charge battery 48 by transmitting electricity from inverter 100 (e.g. electricity generated by electric motor/generator 32) through power regulator 102, to battery 48.

In addition to those shown in FIG. 1B, power system 11 may also include a number of other electrical loads and/or sources. For example, in addition to electric motor 46, power system 11 may include various other large, high-voltage electrical loads, such as drive motors 18, connected to power lines 110, 111 of inverter 100. Additionally, power system 11 may have various smaller, low-voltage loads, such as lights, gauges, sensors, fan motors, and the like.

Power-system controls 26 may be configured to control charging and discharging of battery 48, operation of prime mover 30, operation of electric motor/generator 32, operation of electric motor 46, and transmission of electricity through power-transmission system 52 in connection with all of these tasks. Power-system controls 26 may include inverter 100 and power regulator 102. To control the operation of these components, some embodiments of power-system controls 26 may also include one or more other components. For example, as FIG. 1B shows, power-system controls 26 may include a controller 152 operably connected to controller 112 of inverter 100 and to power regulator 102. Controller 152 may also be operatively connected to prime mover 30, electric motor/generator 32, and electric motor 46 in a manner allowing controller 152 to monitor and/or control one or more aspects of the operation of these components. Based on various operating parameters of prime mover 30, electric motor/generator 32, electric motor 46, and/or other components of power system 11, controller 152 may perform high-level control of power system 11. In doing so, controller 152 may control various operating parameters of power system 11 to target values. For example, controller 152 may coordinate control of prime mover 30, electric motor/generator 32, inverter 100, electric motor 46, and power regulator 102 to provide target values for voltage and/or electric current in certain portions of power system 11. Controller 152 may include any suitable information processing device for controlling the components discussed above. In some embodiments, controller 152 may include one or more microprocessors and/or one or more memory devices programmed to operate in the manners discussed below.

Power-system controls 26 may also include components for monitoring various aspects of the operation of power system 11. For example, power-system controls 26 may include provisions for monitoring the magnitude of electricity exchanged between battery 48 and power-transmission system 52. For instance, in the embodiment shown in FIG. 1B, power-system controls 26 may include a current sensor 146 for sensing a magnitude of electric current exchanged between battery 48 and power-transmission system 52. Current sensor 146 may also sense the direction or sign of the battery current, i.e., whether the electric current is flowing to battery 48 from power-transmission system 52 or vice-a-versa. Current sensor 146 may be directly or indirectly operably connected to controller 152 to allow controller 152 to monitor the magnitude and direction of electric current being exchanged between battery 48 and power-transmission system 52. In addition to or instead of provisions for monitoring the magnitude of electric current exchanged between battery 48 and power-transmission system 52, power-system controls 26 may include provisions for monitoring other measures of the magnitude of electricity exchanged between battery 48 and power-transmission system 52. For example, power-system controls 26 may have provisions for monitoring the magnitude of electric power exchanged between battery 48 and power-transmission system 52. Such provisions may include a voltage sensor 144 for sensing a voltage across terminals 54, 56 of battery 48. Like current sensor 146, voltage sensor 144 may be directly or indirectly operably connected to controller 152 to allow controller 152 to monitor the voltage level of battery 48. With information regarding the magnitude of the current and voltage of the electricity exchanged between battery 48 and power-transmission system 52, power-system controls 26 may be able to determine the magnitude of electrical power exchanged between battery 48 and power-transmission system 52.

Machine 10 and power system 11 are not limited to the configurations shown in FIGS. 1A and 1B and discussed above. For example, power-system controls 26 may include various other configurations and/or arrangements for controlling the transmission of electricity between the various components of power system 11. Such other configurations of power-system controls 26 may include additional control components communicatively linked to one another and operable to share control tasks, such as other controllers, in addition to controller 152. Additionally, power-system controls 26 may include other numbers and/or configurations of power regulators, electrical connectors, and other components that transmit power between the power loads and power sources of power system 11. Power system 11 may also include other batteries, in addition to battery 48. Additionally, electric motor 46 may serve a function other than rotating superstructure 20 around axis 34, such as moving other components of machine 10 or supplying mechanical power to propel machine 10. Furthermore, machine 10 may be any of a number of types of machines other than an excavator, including a stationary machine.

### INDUSTRIAL APPLICABILITY

Machine 10 and power system 11 may have use in any application requiring power to perform one or more tasks. During operation of machine 10, power-system controls 26 may activate various electric loads to perform various tasks, such as activating electric motor 46 to rotate superstructure 20 around axis 34. Power system 11 may provide the electricity required to operate electric motor 46 and any other electric loads from various sources in various situations. Depending on the circumstances, power system 11 may provide electricity to electric motor 46 and the other electric loads from one or both of electric motor/generator 32 and battery 48.

When the electrical needs of electric motor 46 and other electrical loads of power system 11 are high, power-system controls 26 may operate power-transmission system 52 to supply electricity from battery 48 to one or more of the electrical loads of power system 11. At other times, power-system controls 26 may control power-transmission system 52 to supply electricity to battery 48 to recharge it. As noted above, the discharging and charging cycles experienced by battery 48 may degrade its ability to receive and hold electrical charge. Eventually, battery 48 may degrade to a point where it is no longer useful, which may be considered an end-of-life condition for battery 48. Additionally, before battery 48 reaches the end of its life, degradation of the condition of battery 48 and reduction in its electrical capacity may significantly affect how power-system controls 26 should operate power system 11, particularly how power-system controls 26 should control the charge level of battery 48. For example, if the storage capacity of battery 48 decreases to 85% of its original storage capacity, power-system controls 26 should not attempt to charge battery 48 to its original capacity, but only to its new, reduced capacity.

Thus, it would prove useful to power-system controls 26 to evaluate at various points during the life of battery 48 whether it has reached the end of its useful life and, if not, how much the discharging and charging cycles it has experienced have diminished its capacity. Power-system controls 26 may do so in a variety of ways. In some embodiments, power-system controls 26 may monitor the electricity received by and discharged from battery 48, using this information to estimate the amount of degradation and capacity reduction experienced by battery 48. For example, to monitor the discharging and charging cycles of battery 48, controller 152 may log information related to the magnitude and direction (i.e., sign) of electricity exchanged between battery 48 and power-transmission system 52. In some embodiments, this may involve controller 152 receiving and logging from current sensor 146 signals indicative of the magnitude and direction (i.e., sign) of electric current exchanged between battery 48 and power-transmission system 52. Alternatively, controller 152 may log a history of a magnitude of electric power exchanged between battery 48 and power-transmission system 52.

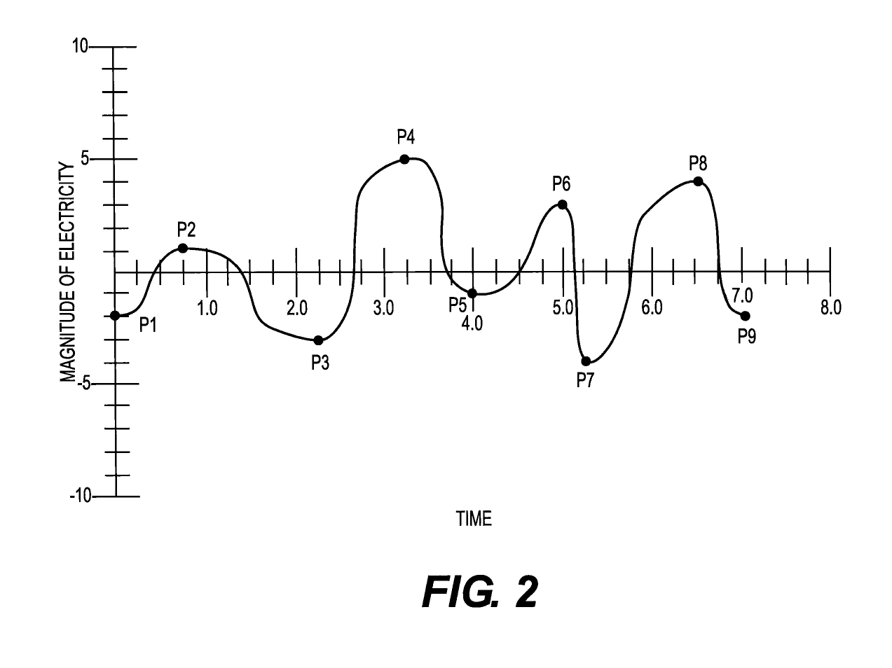

FIG. 2 presents an example of how the magnitude of electricity exchanged between battery 48 and power-transmission system 52 might vary over a period of time. As shown in FIG. 2, the magnitude and duration of charging and discharging electricity exchanged between battery 48 and power-transmission system 52 may fluctuate significantly during operation of power system 11. This may result from variation in the loads experienced by power system 11. For example, where motor 46 uses electricity from battery 48 to rotate superstructure 20, motor 46 may require significantly more electricity to do so during times when implement 36 has a load than during times when implement 36 is empty.

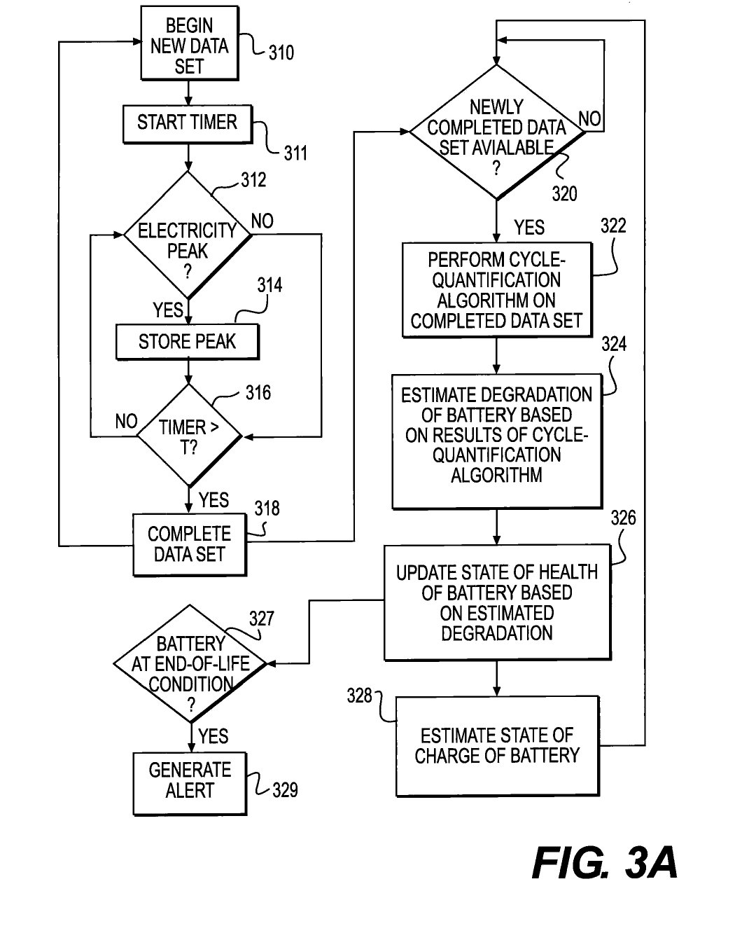

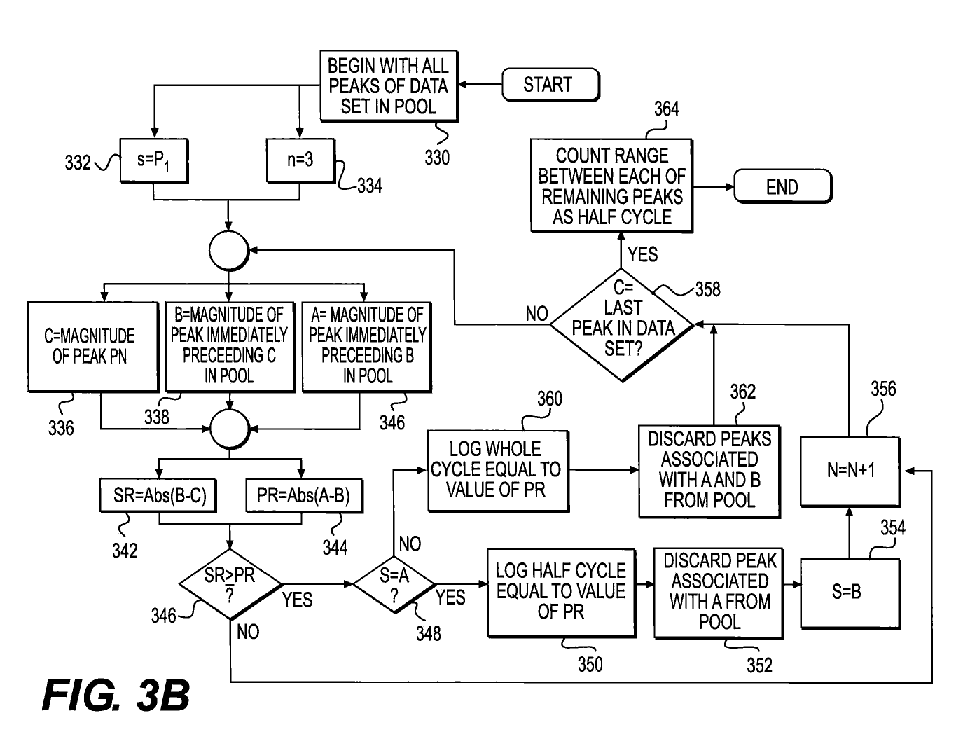

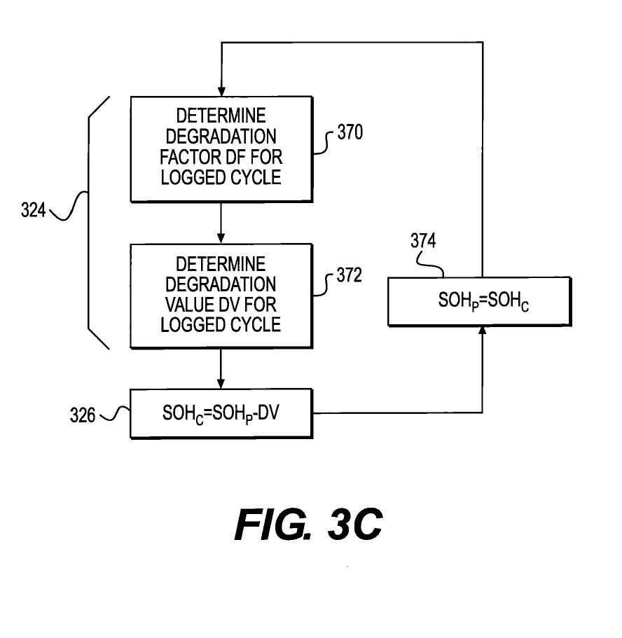

FIGS. 3A-3C illustrate one exemplary approach well-suited for analyzing data like that shown in FIG. 2 to evaluate an amount of degradation experienced by battery 48 due to discharging and charging cycles, as well as using that information to monitor the state of charge of battery 48 and evaluate whether battery 48 has reached the end of its useful life. FIG. 3A provides a high-level overview of a process, and FIGS. 3B and 3C provide more detail regarding certain of the steps shown in FIG. 3A. The process shown in FIG. 3A may begin when power-system controls 26 begin monitoring the electricity transferred to and from battery 48 at the beginning of the timeline on the horizontal axis in FIG. 2. The process of FIG. 3A may begin with power-system controls 26 beginning a new data set (step 310) for collection of data regarding the electricity transferred to and from battery 48. Subsequently, power-system controls 26 may continually evaluate whether the magnitude of the electricity transferred to or from battery 48 has peaked (step 312). Power-system controls 26 may, for example, ascertain that a peak has occurred when the first derivative of the magnitude of the electricity switches from positive to negative or vice-a-versa. Using this or another method, power-system controls 26 may determine that the history of electricity shown in FIG. 2 includes peaks at P1, P2, P3, P4, P5, P6, P7, P8, and P9. Each time power-system controls 26 identify one of these peaks, power-system controls 26 may store the magnitude of electricity and the time at which the peak occurred (step 314) in the data set.

Power-system controls 26 may continue recording electricity peaks in a given data set for a fixed amount of time before starting a new data set. Power-system controls 26 may employ various logistical approaches for doing so. In the example, shown in FIG. 2, power-system controls 26 may start a timer (step 311) after beginning a new data set, and power-system controls 26 may repeatedly evaluate whether the timer exceeds a reference time interval T (step 316). If not, power-system controls 26 may continue monitoring for and storing peaks. When the timer does exceed reference time T, power-system controls 26 may complete the data set (step 318) and begin a new data set step (310).

During the process of identifying and logging peaks in a data set, power-system controls 26 may also continually monitor for the completion of a data set (step 320). When a newly completed data set becomes available, power-system controls 26 may begin a process for estimating the degradation of battery 48 as a result of the discharging and charging cycles represented by the data contained in the newly completed data set. In some embodiments, this process may involve performing a cycle-quantification algorithm on the completed data set (step 322) to generate a quantitative representation of the electricity cycles that occurred during the period the data set was compiled. The cycle-quantification algorithm and the resulting quantitative representation may take various forms. As described in greater detail below, in some embodiments, power-system controls 26 may employ a “rain flow” cycle quantification method to determine a plurality of representative cycles that collectively approximate the charging and discharging activity during the period that the data set was gathered. In some embodiments, each of the determined representative cycles may, for example, be identified as either a half cycle of battery 48 (i.e., only a charging cycle or a discharging cycle) or a whole cycle (i.e., both a charging cycle and a discharging cycle). Additionally, power-system controls 26 may determine for each cycle a magnitude and a duration of the cycle (i.e., how much the magnitude of electricity changed during the cycle and how long the cycle lasted).

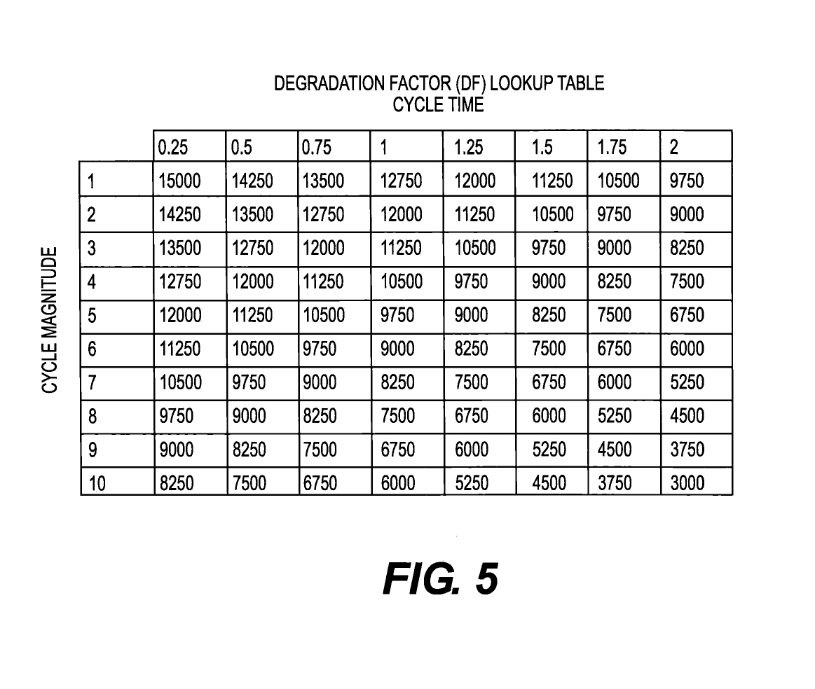

After using a cycle-quantification algorithm to generate a quantitative representation of the charging and discharging cycles associated with a completed data set, power-system controls 26 may use this information to estimate a resulting amount of degradation of battery 48 (step 324). This may involve, using theoretical and/or empirical information in combination with one or more of the values generated in the cycle-quantification algorithm to estimate an amount of degradation of the battery during the period represented by the data set. One approach for doing so is discussed in greater detail below in connection with FIGS. 3C and 5.

After determining the amount of degradation of battery 48 due to the charging and discharging cycles associated with a data set, power-system controls 26 may update a state of health estimation for battery 48 (step 326). In some embodiments, the state of health estimate for battery 48 may be expressed as a percentage of life of battery 48 left and/or a percentage of energy-storage capacity left. In such an embodiment, when battery 48 is new, power-system controls 26 may have stored estimates of 100% life and 100% capacity left for battery 48. Subsequently, if power-system controls 26 estimate 2% degradation of the life and energy-storage capacity of battery 48 due to the charging and discharging cycles associated with the first data set, power-system controls 26 may update the estimated state of health to 98% life and 98% storage capacity remaining.

After updating the state of health estimate for battery 48, power-system controls 26 may evaluate whether battery 48 has reached the end of its useful life (step 327). Power-system controls 26 may do so in various ways. In some embodiments, power-system controls 26 may do so by determining whether the remaining battery life and/or charging capacity has decreased to 0%. If so, power-system controls 26 may generate an alert that battery 48 has reached the end of its life, so that it can be replaced.

Power-system controls 26 may also use the updated estimate of battery health in estimating the state of charge of battery 48 (step 328). Generally, the state of charge of battery 48 may be evaluated relative to the amount of charge battery 48 can hold, or its capacity. Thus, as the estimated capacity of battery 48 decreases with accumulation of charging and discharging cycles, power-system controls 26 can more accurately evaluate the true state of charge of battery 48 at any given point with reference to the updated estimate of the state of health of battery 48.

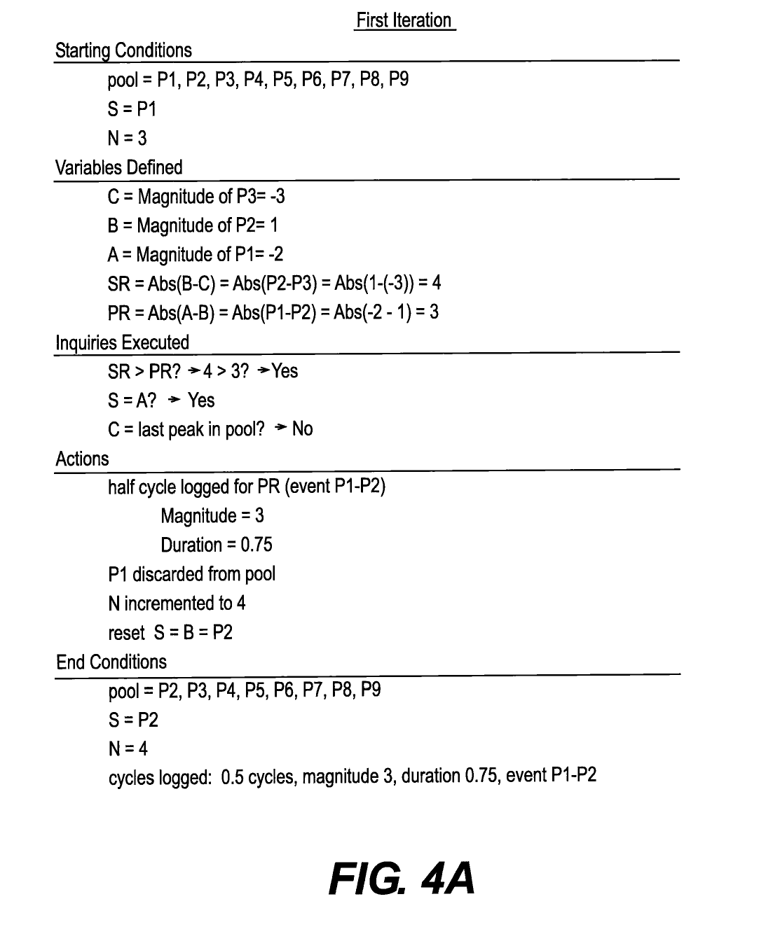

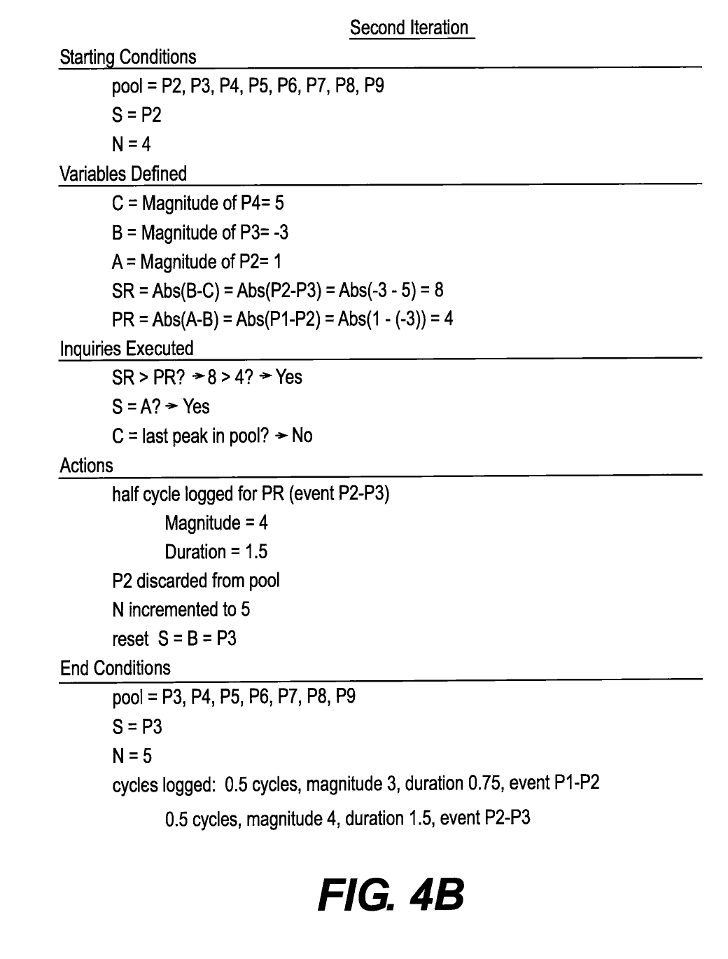

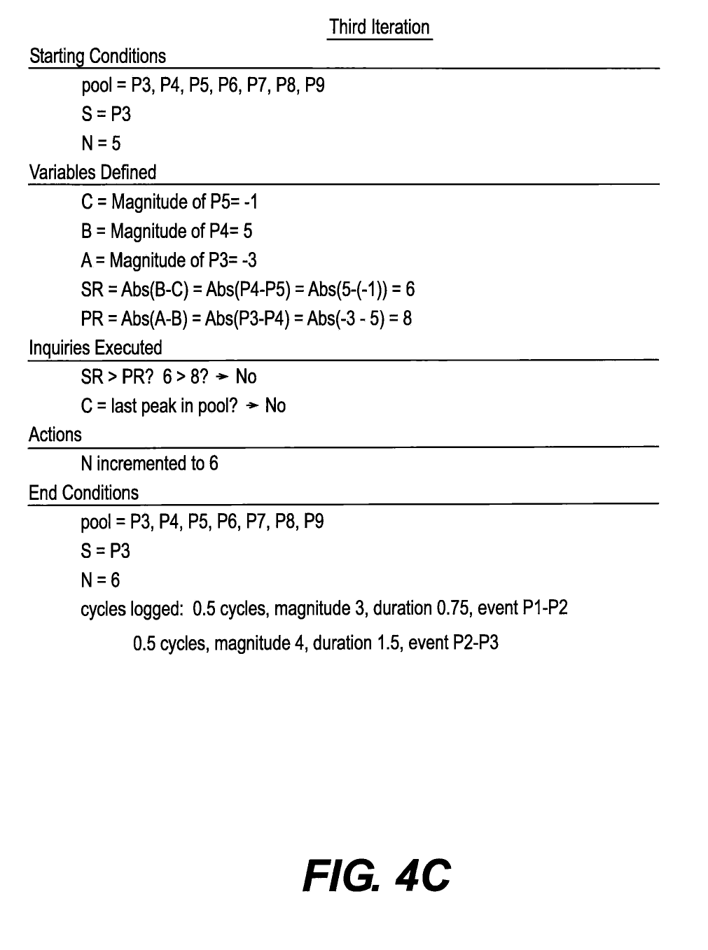

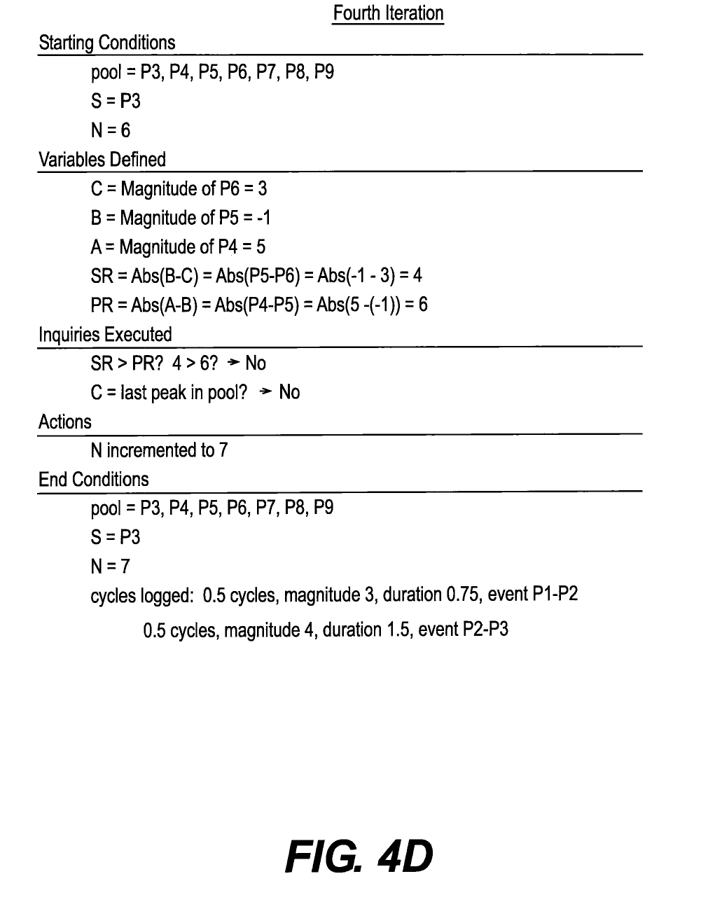

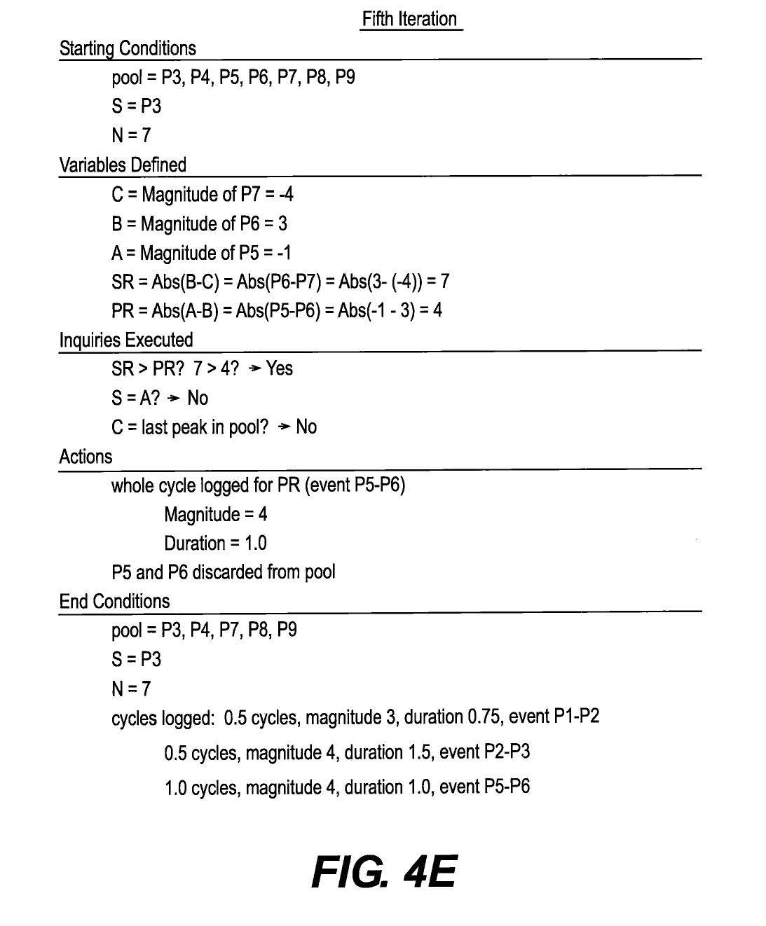

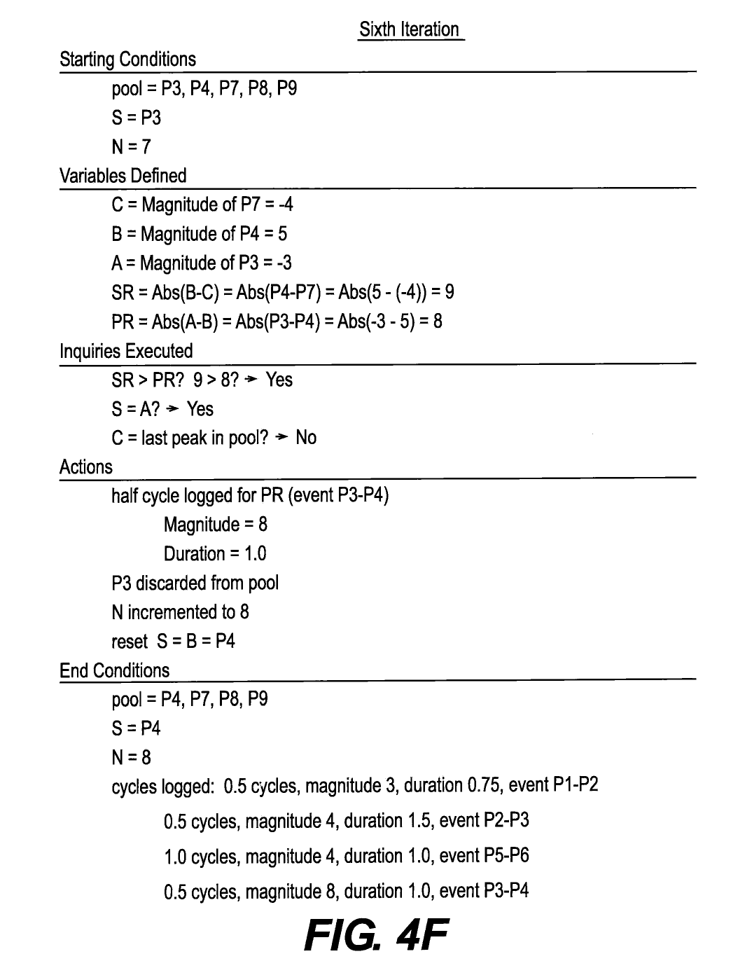

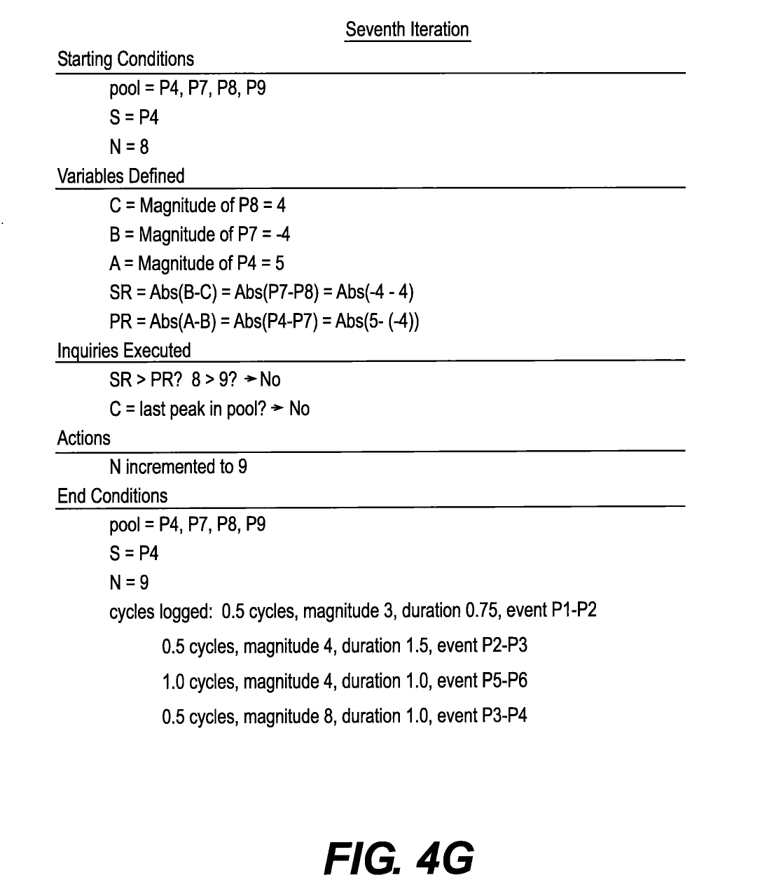

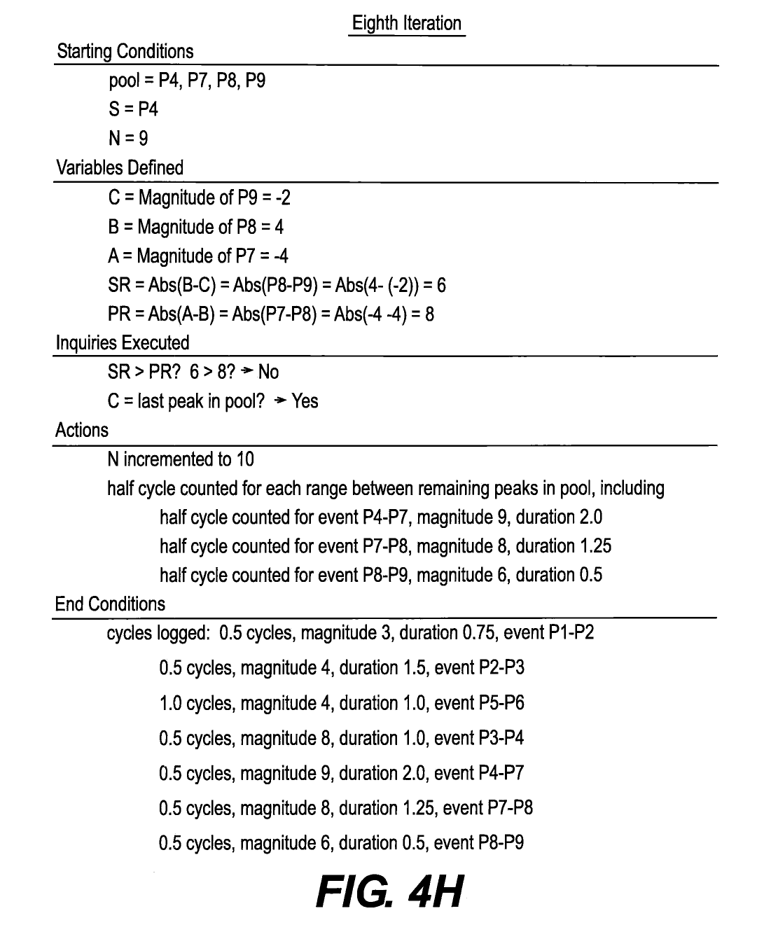

With the foregoing overview of the exemplary process of FIG. 3A, FIG. 3B illustrates one possible cycle-quantification algorithm power-system controls 26 may use to generate a quantitative representation of a data set such as that illustrated in FIG. 2. The cycle-quantification algorithm shown in FIG. 3B constitutes an example of a “rain flow” approach according to ASTM standard E 1049. To facilitate understanding of the process illustrated in FIG. 3B, FIGS. 4A-4H track various variables used in the process of FIG. 3B as power-system controls 26 generate a quantitative representation of the cycles occurring in the history of electricity exchange represented in FIG. 2. FIG. 4A corresponds to a first iteration of the process of FIG. 3B, and each of FIGS. 4B-4H corresponds to a subsequent iteration. At the beginning, power-system controls 26 may start with all of peaks P1, P2, P3, P4, P5, P6, P7, P8, and P9 of FIG. 2 in a pool (step 330).

Subsequently, power-system controls 26 may define the value of some variables used in executing the process. For example, power-system controls 26 may set a variable S equal to P1 (step 332), and power-controls 26 may set a variable N equal to 3 (step 334). Power-system controls 26 may then set a variable C equal to the magnitude of electricity at peak PN (step 336). In other words, with N equal to 3, C is set equal to the magnitude of peak P3 shown in FIG. 2, specifically −3. At step 338, power-system controls 26 may also set a variable B equal to the magnitude of electricity at the peak immediately preceding C in the pool of peaks, here peak P2, having a magnitude of 1. Similarly, at step 340, power-system controls 26 may set a variable A equal to the magnitude of electricity at the peak immediately preceding B in the pool of peaks, here peak P1, having a magnitude of −2.

With the values of variables C, B, and A set, power-system controls 26 may determine the value of a variable SR (step 342) representative of a subsequent range and the value of a variable PR (step 344) representative of a preceding range. The variable SR may represent the amount of change in the magnitude of electricity between two peaks of the electricity history, and the variable PR may represent the amount of change in the magnitude of electricity between two preceding peaks in the electricity history. Accordingly, the value of each variable SR and PR may be defined as the absolute value of the difference between the magnitude of electricity at two consecutive peaks in the electricity history. For example, the variable SR may be defined as the absolute value of B minus C. In the first iteration of the process, this corresponds to the absolute value of P2 minus P3, or the absolute value of 1 minus −3, which is 4. The variable PR may be defined as the absolute value of A minus B. In the first iteration of the process, this corresponds to the absolute value of P1 minus P2, or the absolute value of −2 minus 1, which is 3.

After determining the values of SR and PR to represent the amount of change in the magnitude of electricity between respective peaks of the electricity history, power-system controls 26 may compare the values of these variables to see if the subsequent range SR has a magnitude greater than or equal to the preceding range PR (step 346). In the case of the first iteration of evaluation of the data shown in FIG. 2, SR has a value of 4 and PR has a value of 3, making SR greater than or equal to PR. According to the exemplary algorithm illustrated in FIG. 3B, whenever it is determined that SR is greater than or equal to PR, a representative half or whole cycle may be logged as forming part of the quantitative representation of the electricity history. The algorithm decides whether to log a half cycle or a whole cycle based on whether the variable S and the variable A correspond to the same peak (step 348). In the first iteration, S and A both correspond to peak P1, so the algorithm logs a half cycle for event P1 to P2 (step 350). This may involve logging both the magnitude of the half cycle and the duration of the half cycle. In the case of the event for P1 to P2, the magnitude of the half cycle would equal the value of PR, which is 4, and the duration of the half cycle would equal the elapsed time between P1 and P2, which FIG. 2 shows is 0.75.

After logging a half cycle for event P1 to P2, the algorithm may adjust some of its variables in preparation for the second iteration through the data. To account for the fact that a half cycle has been logged for event P1 to P2 and avoid any double-counting for this event, the algorithm may discard peak P1 from the pool of data to be analyzed (step 352). The algorithm may then redefine variable S as the peak currently associated with variable B (step 354). Additionally, to advance the evaluation forward among the peaks, the algorithm may increment N by 1 (step 356), in this case from 3 to 4. Finally, before beginning the second iteration of the cycle-quantification process, the algorithm may check to see if it has reached the end of the data for the data set by checking whether the variable C is associated with the last peak in the pool of data (step 358). At the end of the first iteration, with C associated to peak P3, the algorithm has not reached the end of the data and proceeds to the second iteration of the process.

In the second iteration (FIGS. 3B and 4B), because N has been incremented to 4, the analysis shifts upward from the consideration of peaks P1 to P3 that occurred in the first iteration to consideration of peaks P2 to P4. After redefining the succeeding range SR as corresponding to peaks P4 and P3 and redefining the preceding range PR as corresponding to peaks P2 and P3 (steps 336, 338, 340, 342, and 344), the algorithm compares the magnitude of the ranges (step 346). As in the first iteration, this results in a finding that SR does exceed PR. And the algorithm finds that the updated values of the variables S and A correspond to the same peak, specifically peak P2. So, power-system controls 26 complete the second iteration by logging a half cycle for event P2 to P3 (step 350), discarding peak P2 from the pool (step 352), resetting the variable S to equal peak P3 (step 354), incrementing the variable N to 5 (step 356), and determining that the end of the data has not been reached (step 358).

In the third iteration (FIGS. 3B and 4C), the focus of the analysis again shifts upward a peak to peaks P3-P5. Unlike the first two iterations, the third iteration finds that the succeeding range SR does not equal or exceed the preceding range PR (step 346). According to the exemplary algorithm of FIG. 3B, when this happens, power-system controls 26 complete the iteration by proceeding to increment the variable N by one (step 356) and checking whether the end of the data has been reached (step 358) without logging any cycles, discarding any peaks from the pool, or redefining the variable S.

In the fourth iteration (FIGS. 3B and 4D), the focus again shifts upward to peaks P4-P6. In this iteration, the algorithm again finds that the succeeding range SR does not equal or exceed the preceding range PR (step 346). So, the power-system controls 26 again increment the value of the variable N to 7 (step 356), verify that the end of the data has not been reached (step 358), and proceed to the fifth iteration.

In the fifth iteration (FIGS. 3B and 4E), with the focus shifted to peaks P5-P7, the algorithm finds that the succeeding range SR does exceed the preceding range PR (step 346), as it did in the first two iterations of the process. Contrasted to the first two iterations of the process, however, the variable S and the variable A do not correspond to the same peak (step 348) because the variable S was not incremented in the last two iterations of the process. When this happens, the exemplary algorithm shown in FIG. 3B logs a whole cycle corresponding to the event associated with the preceding range PR (step 360). In this case, the preceding range PR corresponds to peaks P5 and P6, and the process logs a whole cycle for this event, the cycle having a magnitude of 4 and a duration of 1.0. Subsequently, to account for the fact that a whole cycle has been logged for event P5 to P6, the process discards peaks P5 and P6 from the pool (step 362), leaving peaks P3, P4, P7, P8, and P9 in the pool. The process then checks whether the end of the data has been reached (step 358) and proceeds to the sixth iteration of the process without redefining the variable S or incrementing N.

With the variable N the same as in the fifth iteration and peaks P5 to P6 removed from the pool, the focus of the sixth iteration of the process goes to peaks P3, P4, and P7 (FIGS. 3B and 4F). In this iteration, the process finds that the succeeding range SR exceeds the preceding range PR (step 346) and that the variable S corresponds to the same peak as the variable A (step 348). Accordingly, the power-system controls 26 complete the sixth iteration by logging a half cycle for the event P3 to P4 (step 350), discarding peak P3 from the pool (step 352), redefining the variable S to correspond to peak P4 (step 354), incrementing the variable N to 8 (step 356), and checking whether the end of the data has been reached (step 358).

In the seventh iteration (FIGS. 3B and 4G), the focus shifts to peaks P4, P7, and P8. Here, the algorithm finds that the value of the succeeding range SR (associated with P7 and P8) does not exceed the value of the preceding range PR (associated with P4 and P7) (step 346). So, power-system controls 26 proceed by incrementing the variable N to 9 (step 356), checking to see if the end of the data has been reached (step 358), and moving on to the eighth iteration.

In the eighth iteration (FIGS. 3B and 4H), the focus shifts to peaks P7-P9. In this iteration, power-system controls 26 find that the magnitude of the succeeding range SR (associated with peaks P8 and P9) does not exceed the magnitude of the preceding range PR (associated with peaks P7 and P8). Accordingly, power-system controls 26 again proceed to increment the variable N (step 356) without logging a cycle. Then, power-system controls 26 again check to see if the end of the data in the data set has been reached (step 358), finding this time that it has. When power-system controls 26 find that the end of the data has been reached, they proceed to count a half cycle for the range between each adjacent pair of peaks remaining in the pool (step 364). In the example of FIG. 4H, peaks P4, P7, P8, and P9 remain in the pool when the algorithm reaches the end of the data. So, power-system controls 26 complete the cycle-quantification algorithm by logging a half cycle for event P4 to P7, a half cycle for event P7 to P8, and a half cycle for event P8 to P9. As shown at the bottom of FIG. 411, these newly logged cycles and the previously logged cycles collectively form a quantitative representation of the electrical charging and discharging cycles incurred by battery 48 during the time period shown in FIG. 2.

As discussed above, power-system controls 26 may use such a quantitative representation of a history of charging and discharging cycles to estimate an amount of degradation of battery 48 and update an estimated state of health of battery 48. These processes, which are shown generally in steps 324 and 326 of FIG. 3A, are outlined in more detail in FIG. 3C. To determine the amount of degradation incurred by battery 48 due to a given logged cycle, power-system controls 26 may determine a degradation factor DF related to an estimated severity of degradation resulting from a cycle having the characteristics of the logged cycle (step 370). Two characteristics of a logged cycle that may affect the severity of degradation include the magnitude of the cycle and the duration of the cycle. Generally, the greater the magnitude of a cycle, the greater the degradation occurring as a result of the cycle. Similarly, longer duration cycles generally cause greater degradation of battery 48. Accordingly, power-system controls 26 may determine the degradation factor DF based on one or more equations and/or lookup tables that correlate cycle magnitude and/or cycle duration to different values of the degradation factor DF. These equations and/or lookup tables may be based on theoretical and/or empirical information.

FIG. 5 provides one example of lookup table that power-system controls 26 may use to determine the degradation factor DF used to estimate a degradation value DV for any given cycle. The leftmost column of FIG. 5 lists a series of cycle magnitudes, the topmost row lists a series of cycle times, and the cells in the body of the table list values of the degradation factor DF corresponding to the various combinations of cycle magnitude and cycle duration listed to the left and above the cells. The lookup table in FIG. 5 may be better understood by considering how power-system controls 26 may use it to determine the degradation factor DF for the half cycle logged for event P1 to P2 (see FIG. 4H). Because this half cycle has a magnitude of 3 and a duration of 0.75, power-system controls 26 may look up its degradation factor by finding in FIG. 5 the intersection of the row corresponding to the cycle magnitude of 3 and the column corresponding to the cycle duration of 0.75, which corresponds to a degradation factor DF of 12000.

The values of the exemplary degradation factors DF shown in FIG. 5 are related to how many cycles of a particular magnitude and duration battery 48 can withstand before reaching the end of its life. Thus, the values of the degradation factor DF shown in the example of FIG. 5 may be inversely related to the amount of degradation. It is also contemplated that various other approaches may be taken with respect to the degradation factor DF, including approaches where the value of the degradation factor DF bears a direct relationship to the amount of degradation.

After determining the degradation factor DF associated with a given logged cycle, power-system controls 26 may use that degradation factor DF to determine the amount of degradation associated with a given logged cycle (step 372). The amount of degradation of battery 48 due to a given cycle may be represented in various ways. In some embodiments, the amount of degradation may be expressed as a percentage of degradation, such as a percentage of the life of battery 48 and/or a percentage of the storage capacity of battery 48. To estimate the amount of degradation of battery 48 in terms of a percentage, power-system controls 26 may, for example, use one of the following equations EQ1 and EQ2:

DV=((1/DF)*100%)/2 EQ1

DV=(1/DF)*100% EQ2

Where, DV is the calculated degradation value resulting from the logged cycle and DF is the degradation factor identified for the logged cycle. Power-system controls 26 may use equation EQ1 to calculate the degradation value DV resulting from a given logged half cycle, and power-system controls 26 may use equation EQ2 to calculate the degradation value DV resulting from a given logged whole cycle. The inclusion of the denominator of 2 in EQ1 accounts for the fact that, all other factors equal, a given half cycle should degrade battery 48 by roughly half of what a given whole cycle does. In the case of the logged event of P1 to P2, because this is a half cycle, power-system controls 26 may determine the degradation value associated with this cycle by using the identified degradation factor DF of 300 in equation EQ1 as follows:

DV=((1/DF)*100%)/2=((1/1200)*100%)/2=0.042% EQ1

The exemplary equations included above for determining the degradation value DV have the degradation factor DF in the denominator because the exemplary degradation factors DF of FIG. 5 are inversely related to the amount of degradation associated with each logged cycle. As noted above, it is contemplated that other approaches may be employed, such as using degradation factor DF values that are directly related to the amount of degradation that has occurred. Accordingly, equations other than the above examples may also be used to determine the degradation value DV.

After estimating the amount of degradation incurred by battery 48 due to a given logged cycle, power-system controls 26 may generate an updated state of health of battery 48 (step 326). To do so, power-system controls 26 may, for example, use the following equation:

SOH_{c}=SOHₚ−DV EQ3

Where, SOH_{c} is the current state of health estimate, SOHₚ is the prior state of health estimate, and DV is the previously determined degradation value associated with a logged cycle. The estimated state of health of battery 48 may be represented in various ways. In some embodiments, consistent with the above-discussed examples of expressing degradation in terms of percentages, some embodiments may express the state of health of battery 48 in terms of a percentage, such as percentage of life left or a percentage of energy-storage capacity available. In the case of a new battery 48 that has not yet experienced a discharging cycle, the prior state of health estimate SOHₚ may be considered equal to the initial state of health of the battery, which may be 100%. Thus, if battery 48 was new at the beginning of the timeline in FIG. 2, the prior estimated state of health SOHₚ may be equal to 100% when the above-discussed degradation value DV of 0.042% is estimated for the half cycle logged in connection with event P1 to P2. In such circumstances, power-system controls 26 could use equation EQ3 as follows to update the state of health of battery 48 after the event P1 to P2:

SOH_{c}=SOHₚ−DV=100%−0.042%=99.958% EQ3

Thus, for the example provided in the figures, power-system controls 26 may estimate that battery 48 is at a state of 98.958% healthy after the electricity cycle from P1 to P2 in FIG. 2. After power-system controls 26 have logged another half or whole cycle and estimated a corresponding degradation value DV associated with the logged cycle, power-system controls 26 may again use equation EQ3 to update the current estimated state of health SOHₚ of battery 48 (step 372). Before doing so, power-system controls 26 may reset the prior state of health variable SOHₚ to equal the value of the current state of health variable SOH, (step 374). For example, after estimating that the logged cycle for the event P1 to P2 leaves the current state of health SOH, at 99.958%, power-system controls 26 may set the prior state of health SOHₚ equal to 99.958%. Thus, the next time power-system controls 25 update the current estimated state of health SOH, of battery 48, they would do so by subtracting the degradation value DV of the next logged cycle from 99.958%. In this manner, power-system controls 26 may continue updating the estimated state of health SOH_{c} of battery 48 each time another half or whole cycle is logged. Accordingly, as battery 48 accumulates charging and discharging cycles, the estimated state of health of battery 48 will decline. So, the estimated state of health of battery 48 depends on how many cycles power-system controls 26 have logged for battery 46, as well as the values of the peak magnitudes of electricity, the magnitudes of the cycles, and the durations of the cycles. As discussed above in connection with FIG. 3A, power-system controls 26 may use the repeatedly updated estimate of the state of health of battery 48 to update an estimated state of charge of battery 48 and to determine whether battery 48 has reached the end of its useful life.

The current state of health SOH_{c} of battery 48 may be a monotonic function, such that from its initial value of 100%, it may always decrease because the degradation value DV may always be a positive value. And the state of health SOH_{c} of battery 48 may also have a minimum value of 0% (corresponding to the end-of-life condition), below which it may never decrease.

Systems and methods according to the present disclosure are not limited to the examples discussed above and presented in the drawings. For example, the specific numerical values included in the examples provided above and the figures serve only to facilitate understanding of the principles of the disclosed systems and methods, and any suitable alternative values may be substituted for these examples. Additionally, different approaches of quantifying the electricity history may be used. Similarly, different theoretical and/or empirical information and/or equations may be used to estimate the degradation of battery 48 occurring as a result of the accumulated charging and discharging cycles. Furthermore, the resulting estimates of the degradation of battery 48 as a result of the accumulated charging and discharging cycles may be used in various other ways.

The disclosed embodiments may provide a number of advantages. For example, using a cycle-quantification method like that discussed above to summarize the history of electricity exchange between battery 48 and power-transmission system 52 may provide a practical, effective basis for evaluating how a complex charging and discharging history affects the state of health of battery 48. In turn, this may enable more accurately and effectively monitoring and controlling the state of charge of battery 48, as well as predicting the end of life of battery 48.

It will be apparent to those skilled in the art that various modifications and variations can be made in the disclosed system and methods without departing from the scope of the disclosure. Other embodiments of the disclosed system and methods will be apparent to those skilled in the art from consideration of the specification and practice of the system and methods disclosed herein. It is intended that the specification and examples be considered as exemplary only, with a true scope of the disclosure being indicated by the following claims and their equivalents.

What is claimed is:

1. A method of estimating a state of health of a battery, the method comprising:
receiving information indicative of a history of electricity received by and discharged from the battery during a time period;
using the received information to estimate peaks in the electricity during the time period; and
using an information processor to determine a parameter indicative of an estimated state of health of the battery based at least in part on an estimated magnitude of electricity at each of a plurality of the estimated peaks.

2. The method of claim 1, wherein using the information processor to determine the parameter indicative of an estimated state of health of the battery based at least in part on the estimated magnitude of electricity at each of the plurality of the estimated peaks includes generating a quantitative representation of the history of electricity during the time period based on the estimated peaks.

3. The method of claim 2, wherein generating the quantitative representation of the history of electricity during the time period includes determining a plurality of electricity-cycle magnitudes based at least in part on the estimated peaks.

4. The method of claim 3, wherein generating the quantitative representation of the history of electricity during the time period further includes determining an electricity-cycle duration for each of the determined electricity-cycle magnitudes.

5. The method of claim 4, wherein using the information processor to determine the parameter indicative of an estimated state of health of the battery based at least in part on the estimated magnitude of electricity at each of the plurality of the estimated peaks includes using the determined electricity-cycle magnitudes and electricity-cycle durations to estimate at least one degradation value for the battery due to the history of electricity during the time period.

6. The method of claim 5, wherein using the information processor to determine the parameter indicative of an estimated state of health of the battery based at least in part on the estimated magnitude of electricity at each of the plurality of the estimated peaks further includes using the estimated at least one degradation value for the battery to estimate a remaining capacity of the battery.

7. The method of claim 6, further comprising determining a state of charge of the battery based at least in part on the estimated remaining capacity of the battery.

8. The method of claim 5, further comprising determining whether the battery has reached an end-of-life condition based at least in part on the at least one estimated degradation value for the battery.

9. The method of claim 2, wherein generating the quantitative representation of the history of electricity during the time period includes determining a plurality of electricity-cycle durations based at least in part on when the estimated peaks for each of the determined electricity cycles occurred.

10. A method of estimating a state of health of a battery, the method comprising:
receiving information indicative of a history of electricity received by and discharged from the battery during a time period;
using the received information to identify a plurality of discharging cycles and charging cycles during the time period; and
using an information processor to determine a parameter indicative of an estimated state of health of the battery based at least in part on how many of the discharging cycles and charging cycles of the battery are identified for the time period.

11. The method of claim 10, wherein using the information processor to determine the parameter indicative of the estimated state of health of the battery based at least in part on how many of the discharging cycles and charging cycles of the battery are identified for the time period includes estimating at least one degradation value of the battery from the discharging cycles and charging cycles.

12. The method of claim 11, wherein using the information processor to determine the parameter indicative of the estimated state of health of the battery based at least in part on how many of the discharging cycles and charging cycles of the battery are identified for the time period includes estimating a remaining capacity of the battery based at least in part on the at least one degradation value of the battery from the discharging cycles and charging cycles.

13. The method of claim 10, wherein using the information processor to determine the parameter indicative of the estimated state of health of the battery based at least in part on how many of the discharging cycles and charging cycles of the battery are identified for the time period includes determining an electricity-cycle magnitude for each of the discharging cycles and charging cycles.

14. The method of claim 10, wherein using an information processor to determine a parameter indicative of an estimated state of health of the battery based at least in part on how many of the discharging cycles and charging cycles of the battery are identified for the time period includes determining an electricity-cycle duration for each of the identified discharging cycles and charging cycles.

15. The method of claim 10, further comprising estimating a state of charge of the battery based at least in part on the estimated state of health of the battery.

16. The method of claim 10, further comprising estimating whether the battery has reached an end-of-life condition based at least in part on the estimated state of health of the battery.

17. A method of estimating a state of health of a battery, the method comprising:
receiving information indicative of a history of electricity received by and discharged from the battery during a time period;
using the received information with an information processor to determine for each of a plurality of segments of the time period a degradation value representative of an amount of battery degradation during the segment; and
using the information processor to determine a parameter indicative of an estimated state of health of the battery based at least in part on a plurality of the degradation values.

18. The method of claim 17, further comprising:
using the information processor to determine an electricity-cycle magnitude for each of the plurality of segments; and
wherein determining for each of the plurality of segments of the time period a degradation value representative of the amount of battery degradation during the segment includes determining the degradation value based at least in part on the determined electricity-cycle magnitude for the segment.

19. The method of claim 18, further comprising:
using the information processor to determine an electricity-cycle duration for each of the plurality of segments; and
wherein determining for each of the plurality of segments of the time period a degradation value representative of the amount of battery degradation during the segment further includes determining the degradation value based at least in part on the determined electricity-cycle duration for the segment.

20. The method of claim 17, wherein using the information processor to determine a parameter indicative of an estimated state of health of the battery based at least in part on a plurality of the degradation values includes estimating a remaining capacity of the battery.
